(19) United States
(12) Patent Application Publication
(10) Pub. No.: US 2007/0014268 A1
(43) Pub. Date: Jan. 18, 2007

(54) Method for controlling data transmission in a wireless network system including a plurality of nodes, sensor network using the same and computer-readable medium having thereon a program performing function embodying the same

(75) Inventors: Ho Nyeon Kim, Cheongwon (KR); Jai Yong Lee, Seoul (KR); Seung Woon Yang, Gwangmyung (KR); Jun Jae Yu, Seoul (KR); Kwang Ho Won, Yongin (KR); Jae Ho Kim, Yongin (KR)

Correspondence Address: SUGHRUE MION, PLLC, 2100 PENNSYLVANIA AVENUE, N.W., SUITE 800, WASHINGTON, DC, 20037, US

(73) Assignee: KOREA ELECTRONICS TECHNOLOGY INSTITUTE

(21) Appl. No.: 11/312,463

(22) Filed: Dec. 21, 2005

(30) Foreign Application Priority Data
Jul. 15, 2005 (KR) KR10-2005-0064109

(51) Int. Cl. H04Q 7/24; H04L 12/413

(52) U.S. Cl. 370/338; 370/445

(57) ABSTRACT

The present invention is related to a method for controlling data transmission in a wireless network system including a plurality of nodes. In accordance with the present invention, a duty cycle of a buffer of a node is configured to be adjusted according to a threshold value and a priority of a data to improve energy efficiency according to a variation of a network traffic, guarantee a prioritized transmission of an emergency data, prevent exclusive use of transmission medium by a certain node, and maximize a packet process rate.

### RELATED APPLICATIONS

The present disclosure relates to subject matter contained in priority Korean Application No. 10-2005-0064109 filed on 15 Jul. 2005, which is herein expressly incorporated by reference in its entirety.

### BACKGROUND OF THE INVENTION

1. Field of the Invention

The present invention relates to a method for controlling data transmission in a wireless network system including a plurality of nodes, a sensor network using the same and a computer-readable medium having thereon a program performing function embodying the same, and more particularly to a method for controlling data transmission in a wireless network system including a plurality of nodes, a sensor network using the same and a computer-readable medium having thereon a program performing function embodying the same wherein a duty cycle of a buffer of a node is configured to be adjusted according to a threshold value and a priority of a data to improve energy efficiency according to a variation of a network traffic, guarantee a prioritized transmission of an emergency data, prevent exclusive use of transmission medium by a certain node, and maximize a packet process rate.

2. Description of the Related Art

A sensor network is a core technical infra for realizing a ubiquitous computing technology. A node of a wireless sensor network performs a sensing or a computing using a battery with limited capacity. However, the sensor network is required to transmit the sensed data with minimal energy because the sensor network uses a battery-powered power supply with limited capacity.

Therefore, an energy-efficient MAC (Media Access Control) protocol is required in a MAC hierarchy that controls a data error and a data flow and managing a resource of many hierarchies constituting the wireless network. Because problems such as a packet collision, an overhearing, a control packet overhead and an idle listening occurs when the MAC protocol having a configuration such as a conventional MANET (Mobile Ad-hoc Network) or IEE802.11 is applied to the sensor network, the MAC protocol dedicated especially for the sensor network is developed.

Firstly, S-MAC (Sensor MAC) protocol applies a duty cycle to reduce the idle listening that is a largest energy-wasting factor in the wireless network so that each sensor node is periodically converted to a sleeping mode. Through this periodical conversion to the sleeping mode, energy is saved and an expansion is improved and the collision of packets is prevented by use of contention based scheduling.

In addition, T-MAC (Timeout-MAC) is a MAC protocol for contention based wireless sensor network. In accordance with S-MAC, active/sleeping duty cycle is applied to save energy. However, the duty cycle may not be able to handle a traffic environment variation because it is applied as a fixed format, thereby reducing an energy saving efficiency. Therefore, the energy saving efficiency may be increased corresponding to the traffic environment variation by operating a timer for duty cycle application after transmitting and receiving last data packet through a variable duty cycle.

However, the MAC protocol structures for the conventional sensor network such as the S-MAC and T-MAC have problem described below.

In accordance with an aspect regarding energy efficiency, although the S-MAC using a fixed duty cycle results in better energy efficiency compared to a conventional wireless MAC protocol, the S-MAC performs an unnecessary idle listening even when an amount of data sensed by the node in the sensor network is extremely small, thereby reducing the energy efficiency. Moreover, in accordance with the T-MAC that has been developed to compensate for the disadvantage of the S-MAC by using a variable duty cycle, although the T-MAC employs a method wherein unnecessary idle listening time is reduced by operating the timer, energy is consumed during the time period where a separate timer is set for this operation. In addition, in case of an environment with very large network traffic, duty cycle operation is not possible resulting in inefficient energy saving effect.

In accordance with an aspect regarding a priority, an object of the sensor network is to sensing and transmitting an event. In this case, an emergency data should have a prioritized transmission over a normal data of the sensed data. A priority for transmission should be given to a node that contains a data having a higher priority. However, the conventional MAC structure does not take this priority into any consideration.

In addition, in accordance with an aspect regarding fairness, when one node of many nodes installed in the sensor network uses the transmission medium for a long time, other nodes are vulnerable to fairness. Moreover, the energy consumption of the node is larger than that of other nodes, thereby degrading network efficiency.

In accordance with an aspect regarding a packet delay, when a fixed duty cycle is used, a burst traffic occurs so that the data is transmitted only during a predetermined listening period. Therefore, a disadvantage of not being able to transmit the entire traffic in real time occurs to reduce a packet process ratio.

Therefore, especially for the MAC protocol structure for the sensor network, a novel MAC protocol structure is required wherein the energy efficiency is improved according to a variation in network traffic, prioritized transmission of the emergency data is guaranteed, an exclusive use of the transmission medium by a certain node is prevented and the packet process ratio is maximized.

### SUMMARY OF THE INVENTION

It is an object of the present invention to provide a method for controlling data transmission in a wireless network system including a plurality of nodes wherein a duty cycle of a buffer of a node is configured to be adjusted according to a threshold value and a priority of a data to improve energy efficiency according to a variation of a network traffic, guarantee a prioritized transmission of an emergency data, prevent exclusive use of transmission medium by a certain node, and maximize a packet process rate.

It is another object of the present invention to provide a sensor network using the method for controlling data transmission in the wireless network system including the plurality of nodes.

It is yet another object of the present invention to provide a computer-readable medium having thereon a program performing function embodying the method for controlling data transmission in the wireless network system including the plurality of nodes.

In order to achieve the above-described objects of the present invention, there is provided a method for controlling data transmission in a wireless network system including a plurality of nodes, the method comprising the steps of: (a) setting a mode of a first node in the wireless network system to an active mode; (b) determining whether a data to be transmitted from the first node is a normal data or an emergency data; (c) transmitting a RTS packet from the first node to a second node in the wireless network system when the data is determined to be the emergency data; (d) when the data is determined to be the normal data: (d-1) determining whether an amount of the data accumulated in a buffer of the first node is larger than a predetermined threshold value; and (d-2) transmitting the RTS packet to the second node in the wireless network system when the amount of the data accumulated in the buffer is determined to be larger than the predetermined threshold value; (e) receiving a CTS packet from the second node in the wireless network system; (f) performing a data transmission from the first node to the second node; (g) initializing an operation of a timer having a timeout value when the amount of the data accumulated in the buffer in the step (d-1) is determined to be not larger than the predetermined threshold value, when the CTS packet is not received in the step (e) or when the data transmission is terminated in the step (f); (h) determining whether the first node is receiving the RTS packet from nodes including the second node; (i) transmitting the CTS packet to the node that transmitted the RTS packet when RTS packet is received in the step (h), receiving the data from the node that transmitted the RTS packet, and jumping to the step (g) when the reception of data is complete; (j) terminating the timer when the RTS packet is not received in the step (h) and the timeout value lapses; and (k) setting the mode of the first node in the wireless network system as a sleep mode.

In accordance with the method for controlling data transmission in the wireless network system including the plurality of nodes of the present invention, it is preferable that the timeout value of the timer is sum of a contention interval and a time value that is larger than a propagation time of the RTS packet and smaller than a transmission time of the RTS packet.

In accordance with the method for controlling data transmission in the wireless network system including the plurality of nodes of the present invention, it is preferable that the threshold value can be decreased when a network traffic in the wireless network system is smaller than an expected network traffic.

In accordance with the method for controlling data transmission in the wireless network system including the plurality of nodes of the present invention, it is preferable that the step (c) comprises: (c-1) determining whether an amount of the emergency data accumulated in the buffer of the first node is greater than an emergency threshold value; and (c-2) transmitting the RTS packet from the first node to the second node when the amount of the emergency data accumulated in the buffer of the first node is greater than the emergency threshold value.

In accordance with the method for controlling data transmission in the wireless network system including the plurality of nodes of the present invention, it is preferable that the emergency threshold value is smaller than the threshold value.

In order to achieve the above-described objects of the present invention, there is provided a method for controlling data transmission in a wireless network system including a plurality of nodes, the method comprising the steps of: transmitting an E-RTS packet from a first node in the wireless network system to a second node in the wireless network system; receiving an E-CTS packet from the second node in the wireless network system; and performing a data transmission from the first node to the second node.

In accordance with the method for controlling data transmission in the wireless network system including the plurality of nodes of the present invention, it is preferable that the E-RTS and the E-CTS packets are distinguished from an RTS and a CTS packets by modifying a subtype of the conventional RTS and CTS packets.

In accordance with the method for controlling data transmission in the wireless network system including the plurality of nodes of the present invention, it is preferable that the method further comprises transmitting the E-RTS packet to a third node in the wireless network system from the second node.

In accordance with the method for controlling data transmission in the wireless network system including the plurality of nodes of the present invention, it is preferable that the method further comprises transmitting a B-RTS packet to a fourth node in the wireless network system from the third node.

In accordance with the method for controlling data transmission in the wireless network system including the plurality of nodes of the present invention, it is preferable that the method further comprises setting the fourth node to an active mode after a data transmission between the second node and the third node is complete.

In order to achieve the above-described objects of the present invention, there is provided a sensor network system comprising at least one node embodied by the method for controlling data transmission in a wireless network system including a plurality of nodes in accordance with the present invention.

In order to achieve the above-described objects of the present invention, there is provided a computer-readable recording medium having a program for embodying a function of controlling data transmission in a wireless network system including a plurality of nodes stored thereon, the program performing the functions of: (a) setting a mode of a first node in the wireless network system to an active mode; (b) determining whether a data to be transmitted from the first node is a normal data or an emergency data; (c) transmitting a RTS packet from the first node to a second node in the wireless network system when the data is determined to be the emergency data; (d) when the data is determined to be the normal data: (d-1) determining whether an amount of the data accumulated in a buffer of the first node is larger than a predetermined threshold value; and (d-2) transmitting the RTS packet to the second node in the wireless network system when the amount of the data accumulated in the buffer is determined to be larger than the predetermined threshold value; (e) receiving a CTS packet from the second node in the wireless network system; (f) performing a data transmission from the first node to the second node; (g) initializing an operation of a timer having a timeout value when the amount of the data accumulated in the buffer in the step (d-1) is determined to be not larger than the predetermined threshold value, when the CTS packet is not received in the step (e) or when the data transmission is terminated in the step (f); (h) determining whether the first node is receiving the RTS packet from nodes including the second node; (i) transmitting the CTS packet to the node that transmitted the RTS packet when RTS packet is received in the step (h), receiving the data from the node that transmitted the RTS packet, and jumping to the step (g) when the reception of data is complete; (j) terminating the timer when the RTS packet is not received in the step (h) and the timeout value lapses; and (k) setting the mode of the first node in the wireless network system as a sleep mode.

In accordance with computer-readable recording medium, it is preferable that the timeout value of the timer is sum of a contention interval and a time value that is larger than a propagation time of the RTS packet and smaller than a transmission time of the RTS packet.

In accordance with computer-readable recording medium, it is preferable that the threshold value can be decreased when a network traffic in the wireless network system is smaller than an expected network traffic.

In accordance with computer-readable recording medium, it is preferable that the function (c) comprises: (c-1) determining whether an amount of the emergency data accumulated in the buffer of the first node is greater than an emergency threshold value; and (c-2) transmitting the RTS packet from the first node to the second node when the amount of the emergency data accumulated in the buffer of the first node is greater than the emergency threshold value.

In accordance with computer-readable recording medium, it is preferable that the emergency threshold value is smaller than the threshold value.

In order to achieve the above-described objects of the present invention, there is provided a computer-readable recording medium having a program for embodying a function of controlling data transmission in a wireless network system including a plurality of nodes stored thereon, the program performing the functions of: (a) transmitting an E-RTS packet from a first node in the wireless network system to a second node in the wireless network system; (b) receiving an E-CTS packet from the second node in the wireless network system; and (c) performing a data transmission from the first node to the second node.

In accordance with computer-readable recording medium, it is preferable that the E-RTS and the E-CTS packets are distinguished from an RTS packet and a CTS packet by modifying a subtype of the conventional RTS and CTS packets.

In accordance with computer-readable recording medium, it is preferable that comprising a function of transmitting the E-RTS packet to a third node in the wireless network system from the second node.

In accordance with computer-readable recording medium, it is preferable that comprising a function of setting the third node to an active mode after a data transmission between the first node and the second node is complete.

In accordance with computer-readable recording medium, it is preferable that comprising a function of transmitting a B-RTS packet to a fourth node in the wireless network system from the third node.

In accordance with computer-readable recording medium, it is preferable that comprising a function of setting the fourth node to an active mode after a data transmission between the second node and the third node is complete.

### BRIEF DESCRIPTION OF THE DRAWINGS

FIG. 1 is a flow chart illustrating a method for controlling data transmission in a wireless network system including a plurality of nodes in accordance with the present invention.

FIG. 2 is a diagram illustrating a configuration of a time out value of a timer in the method for controlling data transmission in the wireless network system including the plurality of nodes in accordance with the present invention.

FIGS. 3a and 3b are diagrams illustrating an energy saving effect with respect to various traffics in accordance with the method for controlling data transmission in the wireless network system including the plurality of nodes of the present invention.

FIG. 4 is a diagram illustrating a variation in a threshold value in accordance with the various traffics in the method for controlling data transmission in the wireless network system including the plurality of nodes of the present invention.

FIG. 5 is a diagram illustrating a threshold value with respect to an emergency data in accordance with the method for controlling data transmission in the wireless network system including the plurality of nodes of the present invention.

FIGS. 6a and 6b are diagrams for describing an E-RTS (Emergency-RTS), an E-CTS (Emergency-CTS) and a B-RTS (Booking-BTS) used for a transmission of the emergency data in accordance with the method for controlling data transmission in the wireless network system including the plurality of nodes of the present invention.

FIGS. 7a through 7c diagrams for embodiment of the E-RTS, the E-CTS and the B-RTS used for the transmission of the emergency data in accordance with the method for controlling data transmission in the wireless network system including the plurality of nodes of the present invention.

### DETAILED DESCRIPTION OF THE INVENTION

Method for controlling data transmission in a wireless network system including a plurality of nodes, a sensor network using the same and a computer-readable medium having thereon a program performing function embodying the same in accordance with the present invention will now be described in detail with reference to the accompanied drawings.

The method for controlling data transmission in a wireless network system including a plurality of nodes is configured to optimize an energy saving effect of a sensor node operating with a limited energy according to various traffic environments. Therefore, the method for controlling data transmission in a wireless network system including a plurality of nodes has following characteristic. Firstly, a threshold value is applied to a buffer of each sensor node, a priority is guaranteed for an emergency data, and a scheduling using an efficient timer and an improved control signal are applied.

For the above, data collected in the sensor network is classified into two data as follows.

Firstly, a normal sensing data is a periodically sensed data of normal concerned object event.

An emergency sensing data corresponds to an operation that is performed when a condition is satisfied by a certain event.

A normal threshold value and an emergency threshold value are applied to the normal sensing data and the emergency sensing data, respectively.

The object of classifying the data into to category is to observe a normal operation performed in the sensor network with respect to an event of concerned object and to promptly deal with an emergency situation. When the sensed data is a normal data, energy can be saved because the threshold value of the buffer is configured to be proper for the normal data to transmit the data. When the sensed data is an emergency data, the situation can be dealt with through prompt data transmission by setting an emergency threshold value.

In addition, there are many applicable fields that can be supported in the sensor network. Data formats generated in these many applicable field is also various. The energy saving can be optimized and life span of the sensor network can be maximized because the sensed data is transmitted by applying the threshold value to the buffer with respect to these various data.

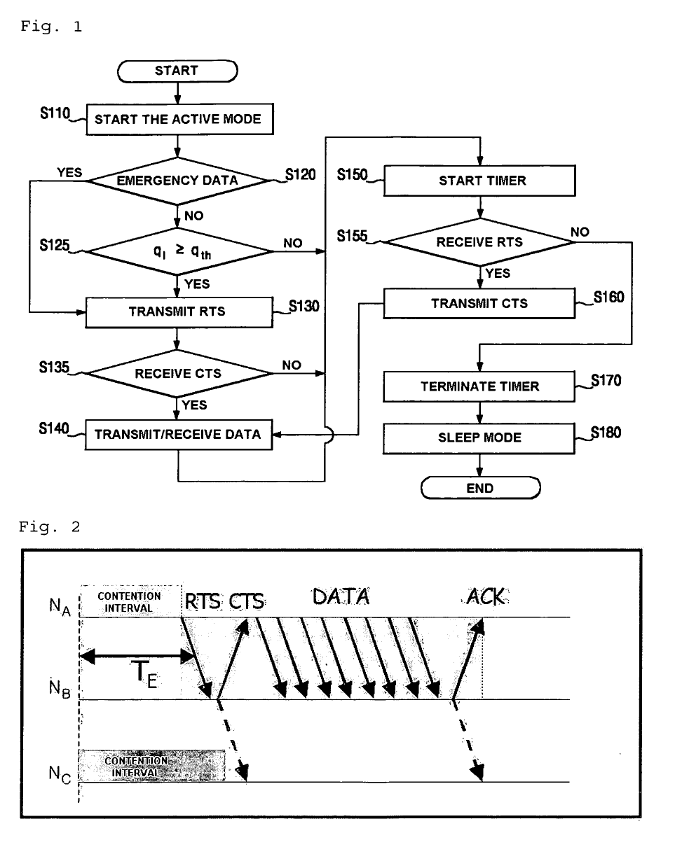

FIG. 1 is a flow chart illustrating a method for controlling data transmission in a wireless network system including a plurality of nodes in accordance with the present invention, wherein process for transmitting data in an active interval by each node in the entire sensor network.

Firstly, during a sleep mode, a sensed data in an active mode is accumulated in a buffer and when an amount of the accumulated data exceeds a predetermined threshold value, an opportunity for transmitting the data is obtained. In order to obtain a transmission medium, a contention-based technique such as IEEE802.11 is applied. When the active mode starts at a node that has obtained the transmission medium, that is, when a radio resource is at an ON state (S110), it is determined whether the data to be transmitted is an emergency data (S120).

When the data is determined not to an emergency data, it is then determined if the amount of the data q₁ accumulated in the buffer is larger than the threshold value qₜₕ (S125). When the amount of the data q₁ accumulated in the buffer is determined to be larger than the threshold value qₜₕ, an RTS (Request To Send) packet is transmitted to a neighboring node in the sensor network (S130).

When the data is determined to an emergency data, the RTS packet is transmitted to the neighboring node in the sensor network without comparing to the threshold value (S130).

Thereafter, after determining whether a CTS (Clear To Send) packet is received from the neighboring node in the sensor network (S135), a data transmission is performed (S140).

When the amount of the data q₁ accumulated in the buffer is larger than the threshold value qₜₕ in the step S125, when the CTS packet is not received in the step S135, or when the data transmission is terminated in the step S140, a timer operation is initiated (S150).

In this case, it is determined that whether the RTS packet is received from the neighboring node in the sensor network (S155). In case of receiving the RTS packet, it is confirmed that there is a data to be transmitted from the neighboring node in the sensor network to itself, whereby the CTS packet is transmitted so as to receive the data (S160) and the data is received through the step S140.

When the RTS packet is not received in the step S155, the timer is terminated (Sl70) and the mode is set to the sleep mode (S180).

Through this operation, each node of the sensor network only consumes an amount of energy necessary for the data transmission to perform an optimized energy management. In addition, when the CTS packet is not received because the amount of the data q₁ accumulated in the buffer is less than the threshold value qₜₕ or the neighboring node to which the data is to be transmitted is in the sleep mode although the amount of the data q₁ accumulated in the buffer is larger than the threshold value qₜₕ, a preset timer is operated to save energy.

FIG. 2 is a diagram illustrating a configuration of a time out value T_{E} of a timer in the method for controlling data transmission in the wireless network system including the plurality of nodes in accordance with the present invention.

The time out value T_{E} is a time interval from the instant when the mode of the node changes from the sleep mode to the active mode to the instant when the mode of the node changes back to the sleep mode. That is, when the time out value T_{E} elapses, the mode is changed to the sleep mode.

As shown, in accordance with the method wherein a periodic duty cycle is applied, the nodes obtain a transmission medium through contention. In accordance with the conventional method, a node that did not obtain a transmission medium performs an idle listening during an active interval with respect to its duty cycle. However, when the node itself does not transmit or receive the data, the timer can be applied to convert the mode into the sleep mode earlier than the given active interval, thereby preventing unnecessary idle listening to save energy.

The time out value T_{E} of the timer, as shown, is set to until the instant when the RTS packet is transmitted from a neighboring node N_{B} to a node N_{A} which has not obtained the transmission medium after the contention interval. When the RTS packet is received, the CTS packet is transmitted as a response and when the RTS packet is not received, the mode is set to the sleep mode. Therefore, the required time out value T_{E} is set as a period where a reception of the RTS packet during the contention interval can be confirmed.

That is, the time out value T_{E} satisfies an equation T_{E}=C+β, where C is the contention interval, R is a length of the RTS packet, Tₓ is a transmission time of the RTS packet, Pₜ is a propagation time of the RTS packet and β satisfies Pₜ<β<<Tₓ. That is, the time out value T_{E} is a sum of a value larger than the propagation time of the RTS packet in a contention interval and a value smaller than the transmission time of the RTS packet.

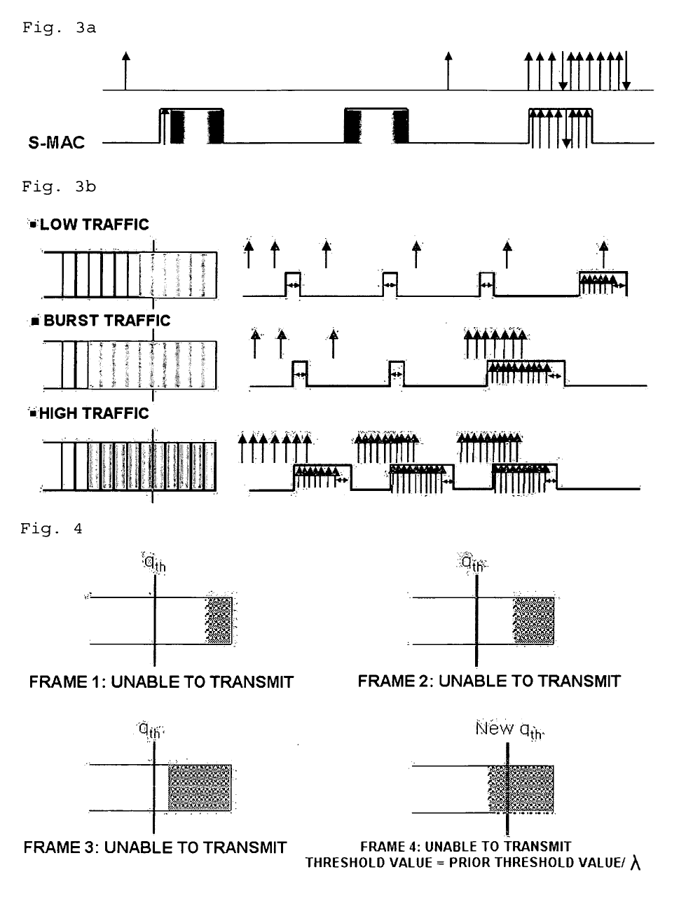

FIGS. 3a and 3b are diagrams illustrating an energy saving effect with respect to various traffics in accordance with the method for controlling data transmission in the wireless network system including the plurality of nodes of the present invention. FIG. 3a illustrates an energy loss in a structure employing a conventional S-MAC, and FIG. 3b illustrates the energy saving effect in accordance with the method for controlling data transmission in the wireless network system including the plurality of nodes of the present invention.

As shown FIG. 3a, the structure employing the conventional S-MAC results in energy waste in a fixed active region when there are little or no sensed data. Particularly, in case that transmission is not performed because there is no sensed data or there is no received data, the sensor network operates same as in case of the idle listening, thereby degrading the energy efficiency. Moreover, in case a large volume of data is sensed, i.e. in case of a burst traffic, a problem of being not able to transmit data during the fixed interval occurs.

Regarding this problem, as shown in FIG. 3b, in accordance with the method for controlling data transmission in the wireless network system including the plurality of nodes of the present invention, when the amount of data is small, the data is accumulated through a buffering until the amount of data is larger than the threshold value and the data is then transmitted to reduced undesirable energy loss. In addition, the active interval is extended until the transmission of the large volume of data is completed for effective transmission.

As described above, although the data can be transmitted using the threshold value to save energy when the method for controlling data transmission in the wireless network system including the plurality of nodes of the present invention may be used, transmission efficiency may be degraded compared to the conventional MAC protocol when the traffic in the entire network is small.

Therefore, the method described below may be used when the method for controlling data transmission in the wireless network system including the plurality of nodes of the present invention is applied to a case where high throughput is required.

FIG. 4 is a diagram illustrating a variation in a threshold value in accordance with the various traffics in the method for controlling data transmission in the wireless network system including the plurality of nodes of the present invention.

In case of small network traffic, a present threshold value qₜₕ is reduced to a threshold value qth/X (where λ>1) when an amount of data accumulated during certain frames is smaller than the threshold value qₜₕ. That is, a transmission probability of the accumulated data is increased by reducing the threshold value. For example, when the data, the amount of which is smaller than the presently set threshold value qₜₕ during the certain frames, the data transmission delay is increased. Therefore, when the data transmission does not occur for a long time, the threshold value is decreased to be smaller than that of the present so as to solve the problem of the data transmission delay.

In addition, In case of large network traffic, the transmission performance of the entire network is similar to that of the conventional MAC protocol because the amount of data accumulated during each frame is always larger than the threshold value qₜₕ.

As described above, the threshold value is configured to vary according to the traffic so that the transmission performance is improved.

Moreover, transmission to a sync node of an emergency event is given a priority compared to a normal sensing data of the objects carried out by the node in the sensor network to take measures for the situation.

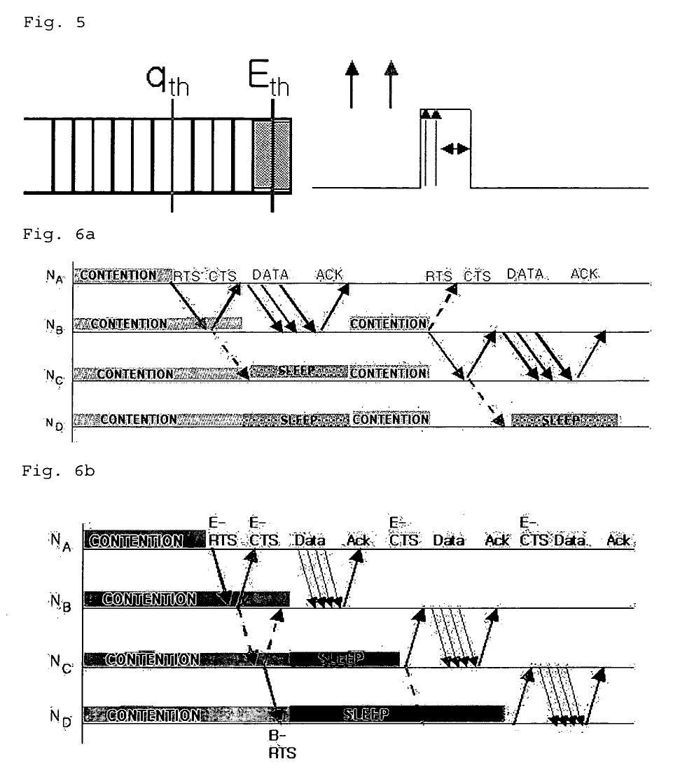

FIG. 5 is a diagram illustrating a threshold value with respect to an emergency data in accordance with the method for controlling data transmission in the wireless network system including the plurality of nodes of the present invention.

As for a method for minimizing a delay with respect to the emergency data, in accordance with the method for controlling data transmission in the wireless network system including the plurality of nodes of the present invention, a sensor node confirms if there is the emergency data of the data accumulated in its buffer during the active interval when the data transmission control method using the threshold value is employed as shown in the step S120 in FIG. 1. If there exist the emergency data, a threshold value Eₜₕ for emergency data transmission which is much smaller than the threshold value qₜₕ for normal data transmission so that the emergency data has higher transmission probability than the normal data, thereby minimizing the data delay and guaranteeing the priority.

FIGS. 6a and 6b are diagrams for describing an E-RTS, an E-CTS and a B-RTS used for a transmission of the emergency data in accordance with the method for controlling data transmission in the wireless network system including the plurality of nodes of the present invention, wherein FIG. 6a illustrates an emergency data transmission using conventional RTS and CTS and FIG. 6b illustrates an emergency data transmission using the E-RTS, the E-CTS and the B-RTS in accordance with the method for controlling data transmission in the wireless network system including the plurality of nodes of the present invention.

The sensor network may be configured to deal with an emergency situation based on a data sensed at the sensor node. This configuration, for example, should be properly established under a situation such as an environment watch. For example, when a data which is at a temperature that may be expected as a forest fire in a forest fire watch system is sensed, this data should be transmitted without any delay compared to a normal data.

As shown in FIG. 6a, a data transmission delay occurs when the conventional RTS/CTS method is used. That is, when a data sensed at a node N_{A} is sequentially transmitted to nodes N_{B}, N_{B} and N_{D}, the data transmission delay occurs according to a contention interval for transmission at each node and a transmission and reception of the RTS/CTS packets.

Compared to this problem, in accordance with the method for controlling data transmission in the wireless network system including the plurality of nodes of the present invention shown in FIG. 6, the node N_{A} has an emergency data and has a priority on transmission over other nodes. For this prioritized transmission, the node N_{A} transmits the E-RTS (Emergency RTS) to the node N_{B} as an indication for an emergency data transmission. As a response, the node N_{B} recognizes that the emergency data transmission is required and transmits the E-CTS (Emergency CTS) to the node N_{B} for a reception thereof. The node N_{C} recognizes that the emergency data transmission is required and transmits the B-RTS (Booking CTS) to the node N_{D} which is in the sleep mode to reserve a data transmission so that a time is reserved by converting the node N_{D} to be active. The nodes N_{C} and N_{D} are converted to be active at the time when the data is to be transmitted. Therefore, a control packet overhead is reduced because the E-CTS is transmitted to receive data without receiving the RTS control packet of higher ranking nodes in order to promptly receive the data from the higher ranking nodes.

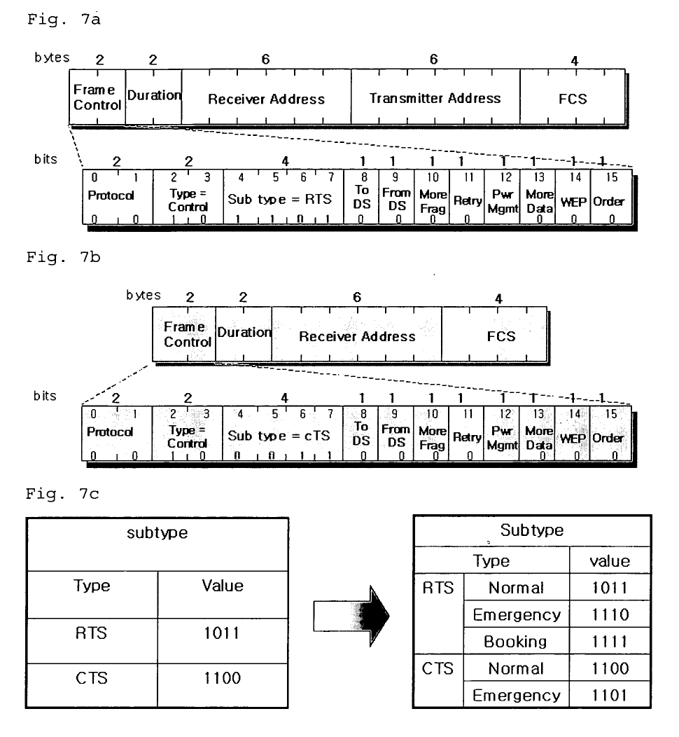

FIGS. 7a through 7c diagrams for embodiment of the E-RTS, the E-CTS and the B-RTS used for the transmission of the emergency data in accordance with the method for controlling data transmission in the wireless network system including the plurality of nodes of the present invention, wherein FIG. 7a illustrates a configuration of a conventional RTS packet frame, FIG. 7b illustrates a configuration of a conventional RTS packet frame, and FIG. 7c illustrates examples of designating subtypes of the E-RTS, E-CTS and B-RTS.

As shown in FIGS. 7a and 7b, the subtype in a frame control part of the conventional RTS/CTS packets has a 4 bit configuration so that sixteen types of representation are possible. However, conventional RTS and CTS are only defined as two types represented as 1011 and 1100, respectively. Therefore, the E-RTS, the E-CTS and B-RTS (Booking RTS) can be expanded without using an additional bit in the conventional RTS/CTS packet frame structures by designating to a subtype portion.

As shown in FIG. 7c, as an example, a subtype of the E-RTS and a subtype of B-RTS may be designated as “1110” and “1111,” respectively, and a subtype of E-CTS may be designated as “1101.”

While the present invention has been particularly shown and described with reference to the preferred embodiment thereof, it will be understood by those skilled in the art that various changes in form and details may be effected therein without departing from the spirit and scope of the invention as defined by the appended claims.

What is claimed:

1. A method for controlling data transmission in a wireless network system including a plurality of nodes, the method comprising the steps of:
(a) setting a mode of a first node in the wireless network system to an active mode;
(b) determining whether a data to be transmitted from the first node is a normal data or an emergency data;
(c) transmitting a RTS packet from the first node to a second node in the wireless network system when the data is determined to be the emergency data;
(d) when the data is determined to be the normal data,
(d-1) determining whether an amount of the data accumulated in a buffer of the first node is larger than a predetermined threshold value; and
(d-2) transmitting the RTS packet to the second node in the wireless network system when the amount of the data accumulated in the buffer is determined to be larger than the predetermined threshold value;
(e) receiving a CTS packet from the second node in the wireless network system;
(f) performing a data transmission from the first node to the second node;
(g) initializing an operation of a timer having a timeout value when the amount of the data accumulated in the buffer in the step (d-1) is determined to be not larger than the predetermined threshold value, when the CTS packet is not received in the step (e) or when the data transmission is terminated in the step (f);
(h) determining whether the first node is receiving the RTS packet from nodes including the second node;
(i) transmitting the CTS packet to the node that transmitted the RTS packet when RTS packet is received in the step (h), receiving the data from the node that transmitted the RTS packet, and jumping to the step (g) when the reception of data is complete;
(j) terminating the timer when the RTS packet is not received in the step (h) and the timeout value lapses; and
(k) setting the mode of the first node in the wireless network system as a sleep mode.

2. The method in accordance with claim 1, wherein the timeout value of the timer is sum of a contention interval and a time value that is larger than a propagation time of the RTS packet and smaller than a transmission time of the RTS packet.

3. The method in accordance with claim 1, wherein the threshold value can be decreased when a network traffic in the wireless network system is smaller than an expected network traffic.

4. The method in accordance with claim 1, wherein the step (c) comprises:
(c-1) determining whether an amount of the emergency data accumulated in the buffer of the first node is greater than an emergency threshold value; and
(c-2) transmitting the RTS packet from the first node to the second node when the amount of the emergency data accumulated in the buffer of the first node is greater than the emergency threshold value.

5. The method in accordance with claim 4, wherein the emergency threshold value is smaller than the threshold value.

6. A method for controlling data transmission in a wireless network system including a plurality of nodes, the method comprising the steps of:
(a) transmitting an E-RTS packet from a first node in the wireless network system to a second node in the wireless network system;
(b) receiving an E-CTS packet from the second node in the wireless network system; and
(c) performing a data transmission from the first node to the second node.

7. The method in accordance with claim 6, wherein the E-RTS and the E-CTS packets are distinguished from an RTS packet and a CTS packet by modifying a subtype of the conventional RTS and CTS packets.

8. The method in accordance with claim 6, further comprising transmitting the E-RTS packet to a third node in the wireless network system from the second node.

9. The method in accordance with claim 8, further comprising setting the third node to an active mode after a data transmission between the first node and the second node is complete.

10. The method in accordance with claim 8, further comprising transmitting a B-RTS packet to a fourth node in the wireless network system from the third node.

11. The method in accordance with claim 10, further comprising setting the fourth node to an active mode after a data transmission between the second node and the third node is complete.

12. A sensor network system, comprising at least one node embodied by the method for controlling data transmission in a wireless network system including a plurality of nodes in accordance with one of claims 1 through 11.

13. A computer-readable recording medium having a program for embodying a function of controlling data transmission in a wireless network system including a plurality of nodes stored thereon, the program performing the functions of:
(a) setting a mode of a first node in the wireless network system to an active mode;
(b) determining whether a data to be transmitted from the first node is a normal data or an emergency data;
(c) transmitting a RTS packet from the first node to a second node in the wireless network system when the data is determined to be the emergency data;
(d) when the data is determined to be the normal data,
(d-1) determining whether an amount of the data accumulated in a buffer of the first node is larger than a predetermined threshold value; and
(d-2) transmitting the RTS packet to the second node in the wireless network system when the amount of the data accumulated in the buffer is determined to be larger than the predetermined threshold value;
(e) receiving a CTS packet from the second node in the wireless network system;
(f) performing a data transmission from the first node to the second node;
(g) initializing an operation of a timer having a timeout value when the amount of the data accumulated in the buffer in the step (d-1) is determined to be not larger than the predetermined threshold value, when the CTS packet is not received in the step (e) or when the data transmission is terminated in the step (f);
(h) determining whether the first node is receiving the RTS packet from nodes including the second node;
(i) transmitting the CTS packet to the node that transmitted the RTS packet when RTS packet is received in the step (h), receiving the data from the node that transmitted the RTS packet, and jumping to the step (g) when the reception of data is complete;
(j) terminating the timer when the RTS packet is not received in the step (h) and the timeout value lapses; and
(k) setting the mode of the first node in the wireless network system as a sleep mode.

14. The computer-readable recording medium in accordance with claim 13, wherein the timeout value of the timer is sum of a contention interval and a time value that is larger than a propagation time of the RTS packet and smaller than a transmission time of the RTS packet.

15. The computer-readable recording medium in accordance with claim 13, wherein the threshold value can be decreased when a network traffic in the wireless network system is smaller than an expected network traffic.

16. The computer-readable recording medium in accordance with claim 13, wherein the function (c) comprises:
(c-1) determining whether an amount of the emergency data accumulated in the buffer of the first node is greater than an emergency threshold value; and
(c-2) transmitting the RTS packet from the first node to the second node when the amount of the emergency data accumulated in the buffer of the first node is greater than the emergency threshold value.

17. The computer-readable recording medium in accordance with claim 16, wherein the emergency threshold value is smaller than the threshold value.

18. A computer-readable recording medium having a program for embodying a function of controlling data transmission in a wireless network system including a plurality of nodes stored thereon, the program performing the functions of:
(a) transmitting an E-RTS packet from a first node in the wireless network system to a second node in the wireless network system;
(b) receiving an E-CTS packet from the second node in the wireless network system; and
(c) performing a data transmission from the first node to the second node.

19. The computer-readable recording medium in accordance with claim 18, wherein the E-RTS and the E-CTS packets are distinguished from an RTS and a CTS packets by modifying a subtype of the conventional RTS and CTS packets.

20. The computer-readable recording medium in accordance with claim 18, further comprising a function of transmitting the E-RTS packet to a third node in the wireless network system from the second node.

21. The computer-readable recording medium in accordance with claim 20, further comprising a function of setting the third node to an active mode after a data transmission between the first node and the second node is complete.

22. The computer-readable recording medium in accordance with claim 20, further comprising a function of transmitting a B-RTS packet to a fourth node in the wireless network system from the third node.

23. The computer-readable recording medium in accordance with claim 20, further comprising a function of setting the fourth node to an active mode after a data transmission between the second node and the third node is complete.
